(19) United States
(12) Patent Application Publication
(10) Pub. No.: US 2003/0165101 A1
(43) Pub. Date: Sep. 4, 2003

(54) Optical information recording medium

(75) Inventor: Noboru Komori, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/376,282

(22) Filed: Mar. 3, 2003

(30) Foreign Application Priority Data
Mar. 4, 2002 (JP) 2002-57194
Mar. 4, 2002 (JP) 2002-57195

(51) Int. Cl. G11B 7/00

(52) U.S. Cl. 369/59.25; 369/53.21

(57) ABSTRACT

The present invention provides an optical information recording medium capable of recording in the best state regardless of types of optical disks. Since recording strategy of the optical disk differs according to materials and manufacturing methods, the optimal recording strategy is recorded on the optical disk by prerecording. Namely, a format representing as to how the recording strategy of the optical disk is recorded is added to a control data zone, particularly a physical format information area so as to be prerecorded before the shipment of the optical disk on an area used to prevent illegal copying. As a result, the optimal recording strategy for the optical disk can be recorded and heat accumulation on the optical disk is absorbed so that a satisfactory recording/reproduction RF signal can be obtained.

### BACKGROUND OF THE INVENTION

1. Field of the Invention

The present invention relates to an optical information recording medium, and particularly relates to the optical information recording medium for recording and reproducing information using a laser beam.

2. Description of the Related Art

An optical information recording medium (optical disk) which is capable of direct-read-after-write type information recording using a laser beam is known. An example of this optical disk is an optical disk (so-called CD-R) which has a comparatively larger capacity than that of a flexible disk and in which the information recording is carried out by emitting a laser beam of a near infrared range (for example, a wavelength in the vicinity of 780 nm) onto a CD-R. The emitted portion of a recording layer absorbs the laser beam so that the temperature of the recording layer rises locally, and the information recording is carried out by a change in an optical characteristic due to a physical or chemical change (for example, generation of a pit).

In recent years, as a computerized society develops, an amount of circulating information tends to increase, and optical disks with a larger capacity (direct-read-after write type digital versatile disk, i.e., DVD-R or DVD-RW) are being circulated for demands for information recording media with large capacity. Such a DVD-R and the like is formed in such a manner a recording layer and a light reflecting layer made of dye, and a protective layer if necessary are provided in this order on a transparent disk-shaped substrate formed with a pregroove for tracking a laser beam to be emitted with a narrow width of not more than half of CD-R (0.74 to 0.8 μm). The recording and reproduction into/from DVD-R is executed by emission of a laser beam with a shorter wavelength (for example, 630 nm to 680 nm) than that of CD-R, so that recording can be executed with higher density than that of CD-R.

Such recording onto an optical disk is executed by a special recording apparatus. For example, recording of information onto a DVD-R or the like is executed by a recording apparatus according to a basic recording strategy set as the standard.

However, since medium makers of DVD-R and the like supply media based on their original techniques and various types of media, the optimum recording strategy which can realize the recording in the best state is slightly different between the media. Therefore, in order to solve a fluctuation in the recording strategy of the respective media, the apparatus makers which provide recording apparatuses incorporate the optimum recording strategies for respective media of media makers into an apparatus main body, and recording is executed by the recording strategies corresponding to respective media so that the recording in the best state is realized for the respective media of the makers.

For example, the recording in the best state is realized in the following manner. A plurality of characteristic parameters of a recording apparatus is stored. The recording apparatus is provided with an operating software (so-called, firmware) for operating the apparatus by discriminating a type of a medium and changing a characteristic parameter according to this type of the medium. A recording strategy, the characteristic parameter of which has been changed is set by the firmware, and the recording is executed by the recording strategy corresponding to the media.

However, an optical characteristic of an optical disk such as a DVD-R is always tried to be improved by changing a physical characteristic and a chemical characteristic in such a manner that a new material is introduced. For this reason, in a recording apparatus which is operated before a new optical disk is supplied, in order to cope with a recording strategy of the new optical disk, a new recording apparatus should be prepared or a firmware should be changed.

### SUMMARY OF THE INVENTION

Taking the above fact into consideration, it is an object of the present invention to obtain an optical information recording medium which is capable of recording in the best state regardless of types of optical disks.

A first aspect of the invention provides an optical information recording medium capable of at least additional recording comprising: a specific information recording area for recording, at the time of the additional recording, specific information, which includes at least a type of the recording medium; and a data recording area for connecting with the specific information recording area, wherein information relating to recording conditions for defining recording signal waveform parameter values at the time of recording is previously recorded onto the specific information recording area.

The optical information recording medium of the invention has at least the specific information recording area capable of at least additional recording and the data recording area. One example of the optical information recording medium includes DVD-R, DVD-R/W and DVD-RAM. The specific information recording area is a recording area for recording the specific information including at least a type of the optical information recording medium at the time of additional recording, and normally the specific information is recorded thereon before the medium is shipped as a product. The specific information includes data representing types of optical information recording media such as DVD-R, DVD-R/W and DVD-RAM. The specific information recording area connects with the data recording area for recording data on a user's side by means of a recording apparatus. In the invention, information relating to the recording conditions for defining the recording signal waveform parameter values at the time of recording is previously recorded on the specific information recording area. As a result, even if the specific information at the time of additional recording onto the optical information recording medium of the invention is not recorded or stored in a recording apparatus, the recording apparatus can be easily set into the optimal state by reading the information relating to the recording conditions, so that the recording in the best state is enabled regardless of types of optical disks.

As the information relating to the recording conditions for defining the recording signal waveform parameter values at the time of recording, strategy data representing self recording strategy can be recorded onto the specific information recording area. Since the recording apparatus executes recording based on the recording strategy, the recording apparatus records the strategy data representing the self recording strategy optimum for the optical information recording medium and reads the strategy data. As a result, the recording apparatus can be easily set into the optimal state and can execute recording in the best state.

Apparatus data representing the recording apparatus can be recorded in the form of the recording signal waveform parameters corresponding to the medium at the time of recording on the specific information recording area. When information is recorded on the optical information recording medium, occasionally the optical information recording medium of the invention already has specific information for making it into optimal for the case where information is recorded onto the optical information recording medium. Therefore, the apparatus data representing the recording apparatus in the form of the recording signal waveform parameter values at the time of recording corresponding to the medium are recorded, so the corresponding recording signal waveform parameter value of the recording apparatus (namely, the optimal recording strategy) can be easily set.

The specific information recording area can adopt a prerecording area for recording information before the shipment of the medium. The prerecording area onto which information is recorded previously by a manufacturing maker is set in the optical information recording medium. Therefore, the specific information is recorded onto the prerecording area before the shipment of the medium as a product and is read, so that the recording apparatus can be set into the optimal state easily and the recording can be executed in the best state.

Differential information from information relating to predetermined reference recording conditions (for example, reference strategy) can be used as the information relating to the recording conditions. As a result, since it is not necessary to record all information, a recording capacity can be reduced.

In addition, the recording of information onto the optical information recording medium can be carried out easily by the following optical information recording apparatus. Specifically, the optical information recording apparatus for recording information onto an optical information recording medium capable of at least additional recording, is characterized by comprising: a storage component for storing information relating to recording conditions for defining recording signal waveform parameter values at the time of recording; and a recording component for recording the information relating to the recording conditions onto the specific information recording area of the optical information recording medium having at least the specific information recording area for recording specific information including at least a type of the medium at the time of the additional recording and a data recording area which connects with the specific information recording area.

The optical information recording apparatus according to a second aspect of the invention records information onto the optical information recording medium capable of at least additional recording. The information relating to the recording conditions for defining the recording signal waveform parameter values at the time of recording is stored in the storage component. The recording component records the information relating to the recording conditions onto the specific information recording area of the optical information recording medium having at least the specific information recording area and the data recording area. When the optical information recording apparatus records specific information at the time of additional recording onto the optical information recording medium, the information relating to the recording conditions based on the optical information recording medium (for example, recording strategy) is recorded on the optical information recording medium. The recording apparatus can be easily set into the optimal state by reading the information relating to the recording conditions, so that the recording can be executed in the best state.

An apparatus which effectively functions at the time of recording information onto the optical information recording medium on which the information relating to the recording conditions based on the optical information recording medium is recorded can be realized by the following optical information recording apparatus.

Namely, a third aspect of the invention provides the optical information recording apparatus for recording information on an optical information recording medium, comprising: a storage component for storing information relating to reference recording conditions, which define recording signal waveform parameter values at the time of recording; a setting component for setting the recording signal waveform parameter values at the time of recording according to the information relating to the reference recording conditions; an information recording component for recording information in the form of the recording signal waveform parameter values set in the setting component onto the optical information recording medium; a reading component for reading the information relating to the recording conditions recorded on the optical information recording medium; and an adjusting component for adjusting the recording signal waveform parameter values set by the information relating to the reference recording conditions so that the information is recorded onto the optical information recording medium in the form of the recording signal waveform parameter values based on the information relating to the recording conditions read by the reading component.

This optical information recording apparatus stores the information relating to the reference recording conditions for defining the recording signal waveform parameter values at the time of recording into the storage component, and allows the setting component to set the recording signal waveform parameter values at the time of recording according to the information relating to the reference recording conditions. The information recording component records information in the form of the recording signal waveform parameter values set by the setting component onto the optical information recording medium. Here, the optical information recording apparatus has the reading component, and reads the information relating to the recording conditions recorded onto the optical information recording medium. The adjusting component adjusts the recording signal waveform parameter values set according to the information relating to the reference recording conditions so that information is recorded in the form of the recording signal waveform parameter values based on the information relating to the recording conditions read by the reading component onto the optical information recording medium. As a results, the optical information recording apparatus is set into the optimal state and can record information in the best state.

The reading component can read the information relating to the recording conditions from a specific information recording area of the optical information recording medium having at least the specific information recording area for recording specific information including at least a type of the optical information recording medium and a data recording area which connects with the specific information recording area.

The reading component can read strategy data representing self recording strategy as the information relating to the recording conditions for defining the recording signal waveform parameter values at the time of recording.

The reading component can read apparatus data representing a recording apparatus by means of the recording signal waveform parameter values at the time of recording corresponding to the medium.

The reading component can read a prerecording area recorded before the shipment of the medium.

The information relating to the recording conditions read by the recording component can adopt differential information of information relating to predetermined reference recording conditions.

A fourth aspect of the invention provides an optical information recording medium capable of at least additional recording which has a read-only area for copying management and formed on an innermost periphery; and a data recording area capable of additional recording. The information relating to the recording conditions, which define the recording signal waveform parameter values at the time of recording are previously recorded on the read-only area.

The optical information recording medium of the present invention is capable of at least additional recording and has at least a read-only area for copying management formed on an innermost periphery and a data recording area capable of additional recording. One example of the optical information recording medium includes DVD-R, DVD-R/W and DVD-RAM. The read-only area is formed on the innermost periphery, and information is recorded thereonto so that interpolation cannot be made for copying management. For example, NBCA data for copying generation management are recorded. In the invention, the information relating to the recording conditions for defining the recording signal waveform parameter values at the time of recording (writing) by means of emission of a laser beam is previously recorded onto the read-only area. As a result, even if specific information is not recorded or stored in the recording apparatus at the time of additional recording on the optical information recording medium of the invention, the recording apparatus can be easily set into the best state by reading the information relating to the recording conditions so as to be capable of executing the recording in the best state regardless of types of optical disks.

As the information relating to the recording conditions for defining the recording signal waveform parameter values of a laser beam at the time of recording, strategy data representing self recording strategy can be recorded onto the read-only area. Since the recording apparatus executes recording based on the recording strategy, the recording apparatus can be easily set into the optimal state by recording strategy data representing self recording strategy based on the optical information recording medium and reading the strategy data so as to be capable of executing the recording in the best state.

Apparatus data representing the recording apparatus can be recorded in the form of the recording signal waveform parameter values at the time of recording corresponding to the medium onto the read-only area. Occasionally, the apparatus for recording information onto the optical information recording medium already has specific information for making the apparatus into the state optimum for the case where information is recorded onto the optical information recording medium of the invention. Therefore, the apparatus data representing the recording apparatus are recorded in the form of the recording signal waveform parameter values at the time of recording corresponding to the medium, so that the corresponding recording strategy suitable for the recording apparatus can be easily set.

The read-only area can adopt an area for recording NBCA data for recording on the innermost periphery of the medium using a bar code or the like. The area where the NBCA data are recorded is previously set in the optical information recording medium by a manufacturing maker. Therefore, specific information is added and recorded onto this area before the shipment of the product and the specific information is read, so that the recording apparatus can be set into the optimal state easily and is capable of executing recording in the best state.

As the information relating to the recording conditions, differential information from predetermined reference strategy information can be used. As a result, since it is not necessary to record all information, a recording capacity can be reduced.

In addition, the information can be easily recorded onto the optical information recording medium by the following optical information recording apparatus. Specifically, the optical information recording apparatus for recording information onto an optical information recording medium capable of at least additional recording is characterized by comprising: a storage component for storing information relating to recording conditions for defining recording signal waveform parameter values at the time of recording; and a recording component for adding the information relating to the recording conditions to information recorded on a read-only area for copying management formed on the innermost periphery so as to record the information.

The optical information recording apparatus of a fifth aspect records information onto the optical information recording medium capable of at least additional recording. The information relating to the recording conditions for defining the recording signal waveform parameter values at the time of recording is stored in the storage component. The recording component adds the information relating to the recording conditions to the information recorded on the read-only area for copying management formed on the innermost periphery so as to record the information. The optical information recording apparatus records the specific information onto the optical information recording medium at the time of additionally recording, the information relating to the recording conditions suitable for the optical information recording medium is recorded on the optical information recording medium, and the information relating to the recording conditions is read, so that the recording apparatus can be easily set into the optimal state (recording strategy) and is capable of executing recording in the best state.

An apparatus, which effectively functions at the time of recording information onto the optical information recording medium where the information relating to the recording conditions based on the optical information recording medium, can be realized by the following optical information recording apparatus.

Namely, a sixth aspect of the invention provides the optical information recording apparatus for recording information on the optical information recording medium, comprising: a storage component for storing information relating to reference recording conditions for defining recording signal waveform parameter values at the time of recording; a setting component for setting the recording signal waveform parameter values at the time of recording (for example, recording strategy) according to the information relating to the reference recording conditions; an information recording component for recording information in the form of the recording signal waveform parameter values set in the setting component onto the optical information recording medium; a reading component for reading the information relating to the recording conditions recorded on the optical information recording medium; and an adjusting component for adjusting the recording signal waveform parameter values set by the information relating to the reference recording conditions so that the information is recorded onto the optical information recording medium in the form of the recording signal waveform parameter values base on the information relating to the recording conditions read by the reading component.

This optical information recording apparatus stores the information relating to the reference recording conditions for defining the recording signal waveform parameter values at the time of recording (for example, recording strategy) into the storage component, and allows the setting component to set the recording signal waveform parameter values at the time of recording according to the information relating to the reference recording conditions. The information recording component records information in the form of the recording signal waveform parameter values set by the setting component onto the optical information recording medium. Here, the optical information recording apparatus has the reading component, and reads the information relating to the recording conditions recorded onto the optical information recording medium. The adjusting component adjusts the recording signal waveform parameter values set according to the information relating to the reference recording conditions so that information is recorded in the form of the recording signal waveform parameter values (for example, recording strategy) based on the information relating to the recording conditions read by the reading component onto the optical information recording medium. As a results, the optical information recording apparatus is set into the optimal state (recording strategy) and can record information in the best state.

The reading component can read the information relating to the recording conditions from the read-only area of the optical information recording medium having at least the read-only area for copying management formed on the innermost periphery and a data recording area capable of additional recording.

The reading component can read strategy data representing self recording strategy as the information relating to the recording conditions for defining the recording signal waveform parameter values at the time of recording.

The reading component can read apparatus data representing a recording apparatus by means of the recording signal waveform parameter values at the time of recording corresponding to the medium.

The reading component can read a prerecording area for NBCA data recorded before the shipment of the medium.

The information relating to the recording conditions read by the recording component can adopt differential information of information relating to predetermined reference recording conditions (for example, recording strategy).

As explained above, according, to the invention, since the information relating to the recording conditions for defining the recording signal waveform parameter values at the time of recording is previously recorded onto the specific information recording area of the optical information recording medium having at least the specific information recording area and the data recording area, even any recording apparatuses for recording information onto the optical information recording medium can be easily set into the optimal state by reading the information relating to the recording conditions such as the recording strategy. As a result, the apparatus produces an effect such that the recording can be executed in the best state.

According to the invention, the information relating to the recording conditions for defining the recording signal parameter values at the time of recording is previously recorded onto the read-only area of the optical recording medium having at least the read-only area for copying management formed on the innermost periphery and the data recording area capable of additional recording. For this reason, even any recording apparatuses for recording information onto the optical information recording medium can be easily set into the optimal state by reading the information relating to the recording conditions, and thus produces an effect that the recording can be executed in the best state.

### BRIEF DESCRIPTION OF THE DRAWINGS

FIG. 1 is a schematic diagram of an optical disk according to a first embodiment of the present invention.

FIG. 2 is a conceptual diagram expressing a recording/reproduction area of the optical disk in one dimension.

FIG. 3 is a schematic structural diagram of a read-in area.

FIG. 4 is a schematic structural diagram of a control data zone.

FIGS. 5A to 5D are explanatory diagrams of recording strategies.

FIG. 6 is a schematic block diagram of a recording apparatus of the optical disk.

FIG. 7 is a schematic diagram of the optical disk according to a second embodiment of the invention.

FIG. 8 is an explanatory diagram for explaining NBCA data.

### DETAILED DESCRIPTION OF THE EMBODIMENTS

There will be detailed below one example of a first embodiment of the present invention with reference to the drawings.

<Optical information recording medium>

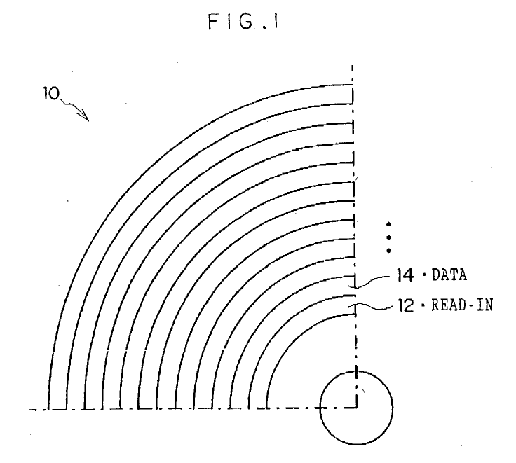

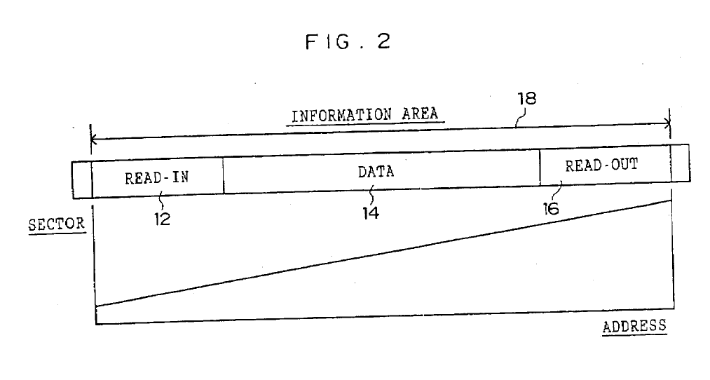

As shown in FIG. 1, an optical disk 10 has an information area 18 which is constituted so that a read-in area 12, a data area 14 and a read-out area 16 formed if necessary (FIG. 2) are provided in this order from an inner periphery towards an outer periphery of the optical disk 10 in order to record various information. The data area 14 is called also as a zone, and the information area 18 is divided into areas so as to be capable of recording/reproducing data by sector unit.

As shown in FIG. 2, when an area of the optical disk 10 where recording or reproducing is carried out is expressed in a one dimension, a position on the optical disk 10 for the recording/reproduction can be specified by a value of an address and a value of a sector. The read-in area 12 composing the information area 18 is an area where types and recording methods of the optical disk 10 are recorded, and the data area 14 is an area where actual data are recorded. The read-out area 16 is an area provided in order to prevent direct-read-after writing when data recording is ended if necessary.

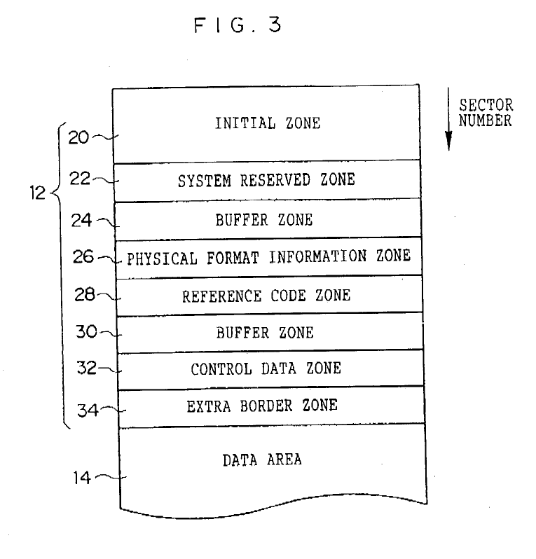

In addition, FIG. 3 shows a detail of the read-in area 12. The read-in area 12 is composed of an initial zone 20, a system reserved zone 22, a buffer zone 24, a R-physical format information zone 26, a reference code zone 28, a buffer zone 30, a control data zone 32 and an extra border zone 34. The extra boarder zone 34 connects with the data area 14.

Incidentally, since the optical disk 10 such as DVD is a large capacity type optical information recording medium, a lot of data can be copied therein. For this reason, data which prevents illegal copying of information unallowed to be copied should be recorded on the optical disk 10, and it is general to record (prerecord) data on the control data zone 32 within the read-in area 12. This data recording is executed by a prerecording-only recording apparatus.

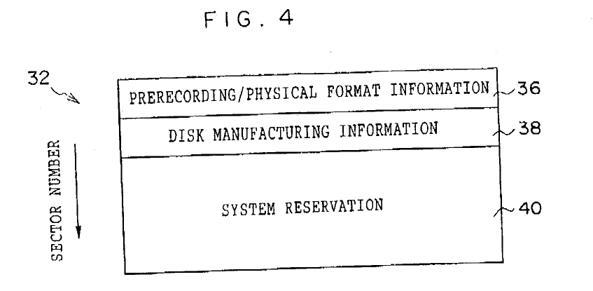

The data recording (prerecording) for preventing illegal copying is executed on the read-in area 12 by manufacturing makers which manufacture the optical disk 10. The prerecording is executed on the control data zone 32. As shown in FIG. 4, the control data zone 32 is composed of a prerecording physical format information area 36, a disk manufacturing information area 38 and a system reserved area 40.

The physical format information area 36 is an area where data formats which represent position, size and contents of data to be recorded on the control data zone 32 are recorded. The disk manufacturing information area 38 is an area where information about manufacturing makers of the optical disk 10 is recorded. The system reserved area 40 is an area which is previously prepared for use on a system side.

A concrete example of the physical format information area 36 includes a version of a plan document used at the time of manufacturing this optical disk, a size such as 12 cm and a maximum transmission rate such as 2.52 Mbps of the optical disk, a structure of the optical disk such as a single layer or a double layer, a depth at the time of recording such as 0.267 μm/bit, allocation of the data area 14, an NBCA descriptor, a starting sector of the extra border zone 34 and the other reserved areas as types of data. As for these data types, position (byte position), contents and size (number of bytes) are stored as the format data.

Incidentally, the information recording on the optical disk such as a DVD-R or a DVD-RW disk is executed by multi-pulse system using a laser output at the time of recording called as a recording strategy taking thermal recording into consideration. The multi-pulse system divides emission of a laser beam into emission of the top pulse and the emission of the multi-pulse for an area where a piece of data is recorded so as to control heat distribution generated in the recording areas. As a result, heat interference between adjacent generated marks and heat accumulation at the backward ends of the generated marks are absorbed, so that a satisfactory recording/reproduction RF signal can be obtained.

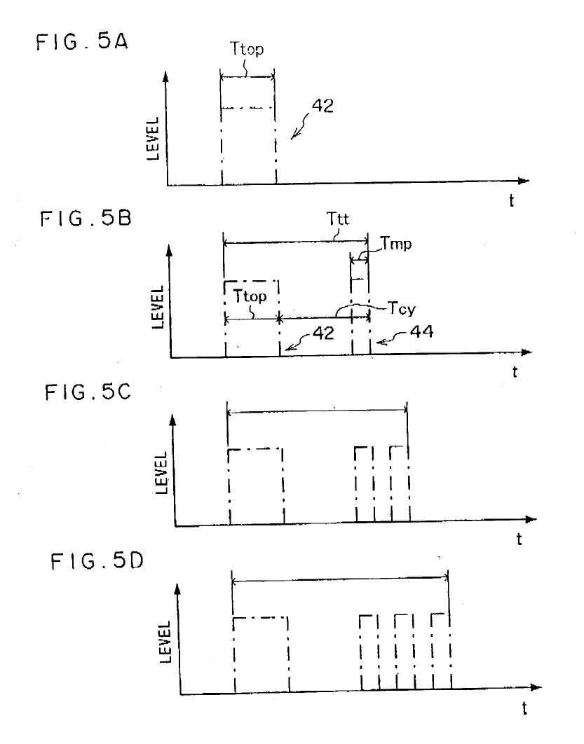

FIGS. 5A to 5D show one example of the recording strategy. As shown in FIGS. 5A to 5D, the recording strategy defines a pulse width and a cycle of a top pulse 42 and one or plural subpulse(s) 44 if necessary. Namely, when a clock signal is T, a signal with a length of 3T to 14T is used. Setting of numerical values of a pulse width Ttop of the top pulse 42 corresponding to 3T to 14T respectively and a pulse width Tmp of the subpulse 44 corresponding to 3T to 14T respectively represent the recording strategies. In this case, the pulse width Tmp of the subpulse 44 is set commonly for the length of the signals of 3T to 14T. Moreover, the pulse width of the top pulse 42 can be set commonly for the length of the signals of 6T to 14T.

FIG. 5A shows one example of the recording strategy of only the top pulse 42, and it is the recording strategy corresponding to the length of the signal of 3T. For example, when the clock signal is T, the recording strategy can be set in such a manner that the pulse width Ttop of the top pulse 42 is defined as 1.55 T. FIG. 5B shows one example of the recording strategy of the top pulse 42 and one subpulse 44, and it is the recording strategy corresponding to the length of the signal of 4T. For example, when the pulse width Ttop of the top pulse 42 is defined as 1.50 T and the pulse width Tmp of the subpulse 44 is defined as 0.65 T, the recording strategy can be set. Moreover, total time Ttt of a pulse signal or a cycle time Tcy from the top pulse 42 to the subpulse 44 may be further defined.

Similarly, FIGS. 5C and 5D show examples of the recording strategy corresponding to the lengths of the signals of 5T and not less than 6T. For example, the recording strategy corresponding to the length of the signal of 5T can be set in such a manner that the pulse width Ttop of the top pulse 42 is defined as 1.55T and the pulse width Tmp of the subpulse 44 is defined as 0.65T and a number of the subpulses 44 is defined. The recording strategy corresponding to the length of the signal of not less than 6T can be set in such a manner that the pulse width Ttop of the top pulse 42 is defined as 1.60T and the pulse width of the subpulse 44 is defined as 0.65T and its number is defined.

The above recording strategies differ according to materials and manufacturing methods of the optical disk 10. Therefore, there is the recording strategy which is the optimum for the optical disk 10. When recording is executed by the recording strategy which is optimum for the optical disk 10, heat accumulation on the optical disk 10 is absorbed, so that satisfactory recording/reproduction RF signal can be obtained.

Therefore, in the embodiment, the recording strategy of the optical disk 10 is recorded on the optical disk 10 by prerecording. Namely, the prerecording is executed on an area to be used for eliminating illegal copying before the shipment of the optical disk 10. More concretely, the recording strategy is recorded on the control data zone 32. The recording on the control data zone 32 can be realized by adding a format representing as to how the recording strategy of the optical disk 10 is recorded on the R-physical format information area 36.

Specifically, a combination of respective data for defining the pulse width Ttop of the top pulse 42 and the pulse width Tmp of the subpulse 44 of the signals with the respective lengths can be adopted. Moreover, in the case where respective data are preset and can be utilized together, identifiers representing the data can be stored. Further, data representing a differential value from a reference recording strategy may be stored. Furthermore, data which represent a name and a model number of a recording apparatus capable of executing recording according to the recording strategy of the optical disk 10 and data which represent a type of the recording strategy to be used in the recording apparatus may be stored.

Next, there will be explained below a recording apparatus 50 which is capable of reading the recording strategy from the optical disk 10 and reflecting it at the time of recording information.

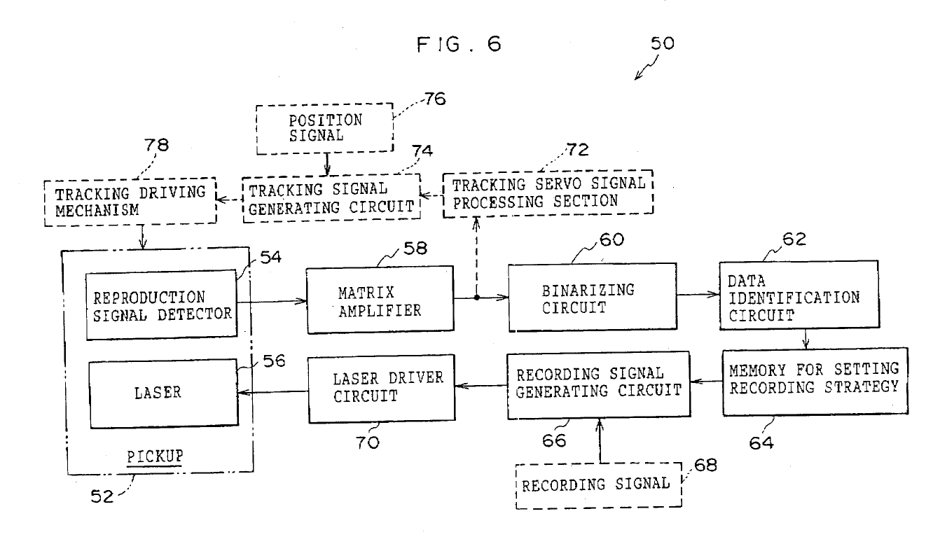

As shown in FIG. 6, the recording apparatus 50 has a pickup 52 for emitting a laser beam for reproducing and recording information from/on the optical disk 10. The pickup 52 has a reproduced signal detector 54 and a semiconductor laser 56. The reproduced signal detector 54 is connected with a matrix amplifier 58 so that a detected signal of the reproduced signal detector 54 is input into the matrix amplifier 58. The matrix amplifier 58 processes the detected signal of the reproduced signal detector 54, and outputs a reproduced signal (RF signal), a phase difference signal (DPD signal) and a push-pull signal (PP signal).

An output side of the matrix amplifier 58 is connected with a binarizing circuit 60, and an RF signal output from the matrix amplifier 58 is input into the binarizing circuit 60. The binarizing circuit 60 is for detecting recorded data from the input RF signal. Namely, the binarizing circuit 60 is a circuit for converting the RF signal as an analog signal into a digital signal. The binarizing signal 60 binarizes an RF signal by setting an RF signal of high level exceeding a predetermined value with a predetermined sampling cycle to a predetermined digital value (for example, “1”) and setting the other low level RF signal to a predetermined digital value (for example, “0”) so as to output the values as detected data.

The binarizing circuit 60 is connected with a data identification circuit 62 and outputs the detected data to the data identification circuit 62. The data identification circuit 62 is a circuit for identifying contents of the recorded data (recorded information) using the input detected data. Concretely, the data identification circuit 62 has a storage device where a maker code representing a manufacturing maker and a strategy code representing a type of a recording strategy are stored. It refers to the storage device so as to identify the recording strategy corresponding to the input detected data.

An identification signal as an identified result of the data identification circuit 62 is output to a memory 64 for setting recording strategy. The memory 64 for setting recording strategy has a table in which identification signals (identified result of the data identification circuit 62) are made to correspond to the setting data for defining actual recording strategies, respectively. The memory 64 for setting recording strategy refers to the stored table and outputs setting data for defining the recording strategy corresponding to the input identified signal to a recording signal generating circuit 66.

The recording signal generating circuit 66 sets a number of pulses, a pulse width and a cycle for driving the semiconductor laser 56 when a piece of data is recorded on the optical disk 10 according to the setting data. The signal of the set number of pulse, pulse width and cycle becomes the optimal recording strategy for the optical disk 10. A recording signal 68 for recording on the optical disk 10 is also input into the recording signal generating circuit 66. Therefore, the recording signal generating circuit 66 converts the input recording signal 68 into a signal due to the recording strategy according to the setting data from the memory 64 for setting recording strategy so as to output the converted signal to the semiconductor laser 56 via a laser driver circuit 70.

The laser driver circuit 70 is a driving circuit for driving the semiconductor laser 56, and drives the semiconductor laser 56 so that on/off operation by means of the input pulse signal from the recording signal generating circuit 66 is performed on the semiconductor laser 56.

In such a manner, the recording apparatus 50 is set by the recording strategy read out from the optical disk 10, and information can be recorded on the optical disk 10 by the optimal recording strategy.

The matrix amplifier 58 is connected also with a tracking server signal processing section 72. The tracking servo signal processing section 72 is connected with a tracking driving mechanism 78 via a tracking signal generating circuit 74. A position signal 76 for moving the pickup 52 to a tracking position is also input into the tracking servo generating circuit 74.

The tracking servo signal processing section 72 is a signal processing section for actuating tracking servo using a PP signal or a DPD signal, and its output signal generates a driving signal of the tracking driving mechanism 78 for tracking the pickup 52 in the tracking signal generating circuit 74. At this time, the pickup 52 can be moved to a defined position by a position signal 76 input from a computer or the like.

Here, as a writer for prerecording on the optical disk 10, the above-mentioned recording apparatus 50 can be used.

In addition, in the case where the data representing the recording strategy prerecorded on the control data zone 32 of the optical disk 10 are read out so that the recording apparatus 50 is adjusted, the recording apparatus 50 requires at least a function for reading data representing recording strategy and make adjustment. In order to obtain this function, an area is secured in the storage device of the data identification circuit 62 and in the table of the memory 64 for setting recording strategy so as to be capable of coping with new recording strategy. Data representing the read recording strategy may be stored in this area. Moreover, the recording signal generating circuit 66 can freely change setting so as to be capable of coping with the new recording strategy.

Namely, in this embodiment, new recording strategy is not previously stored, but the recording strategy read by the optical disk 10 can be set. Such a structure can be realized by updating the existing processing program (firmware) for defining the functions of the data identification circuit 62, the memory 64 for setting recording strategy and the recording signal generating circuit 66. As a result, even in the case of the recording apparatus 50 which has been manufactured before the shipment of the optical disk 10 in the this embodiment, the recording apparatus 50, which is capable of optimally recording information on the optical disk 10 of the embodiment, can be obtained.

The processing program is recorded on a flexible disk as a recording medium, and the recording apparatus 50 is connected with a flexible disk unit (FDU) into which the flexible unit can be inserted/ejected so that the processing program can be easily achieved. Namely, a processing routine is previously recorded on the flexible disk, and the processing program recorded on the flexible disk is executed via FDU. Moreover, the processing program may be executed by updating (installing) the storage device (not shown) on which the firmware of the recording apparatus 50 has been stored. Moreover, the recording medium includes a disk such as CD-ROM, MD, MO or DVD, or a magnetic tape such as DAT. When these media are used, a CD-ROM device, an MD device, MO device, DVD device, DAT device and the like may be used instead of FDU.

Next, there will be detailed below one example of a second embodiment of the invention. The same parts are designated by the same reference numerals in the first embodiment, and the explanation thereof will be omitted.

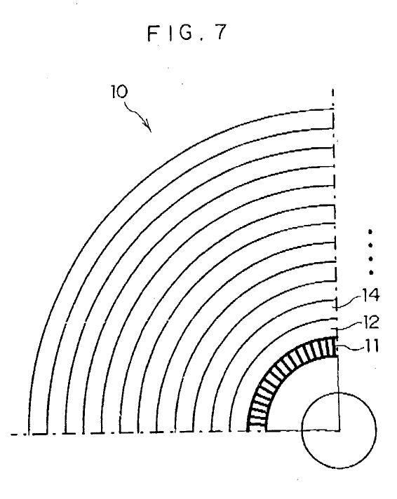

The optical disk 10 in FIG. 7 is composed of a recording layer having a main absorption band, in the vicinity of 700 nm, and has a satisfactory recording/reproduction characteristic for giving high reflectance also to a laser beam with wavelength of not more than 670 nm.

The innermost peripheral portion of the optical disk 10 is provided with an NBCA area 11 for copying management. The NBCA area 11 is formed by a bar code form, and its structure is different from that of the information area 18 (mentioned later).

Since the optical disk 10 such as DVD is a large-capacity type optical information recording medium, it can copy a lot of data. For this reason, data for preventing illegal copying for copying information unallowable to be copied are supposed to be recorded on the optical disk 10, and thus NBCA data are occasionally recorded on the NBCA area 11. This data recording is executed by a special apparatus.

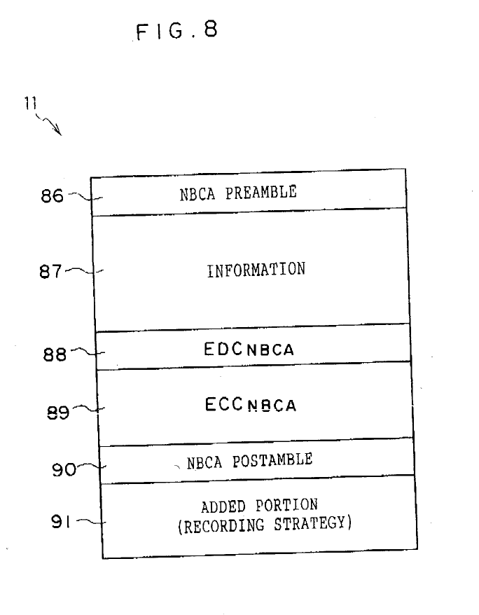

The data for preventing illegal copying are recorded on the NBCA area 11 by a manufacturing maker which manufactures the optical disk 10. Generally, as shown in FIG. 8, the NBCA area 11 is composed of an information area 86 for NBCA preamble, an information area 87 for data to be used for NBCA, an information area 88 for NBCA error detection code, an information area 89 for NBCA error correction code, an information area 90 for NBCA postamble.

In this embodiment, the recording strategy of the optical disk 10 is added to the NBCA area 11 so as to be recorded onto the optical disk 10. Namely, the recording strategy is recorded on the area to be used for excluding illegal copying before the shipment of the optical disk 10. More concretely, an added portion 91 for recording the recording strategy continuously on the information areas 86 through 90 is provided as the NBCA area 11. The recording onto the NBCA area 11 can be achieved by adding a format representing as to how the recording strategy of the optical disk 10 is recorded on the NBCA area 11.

In addition, in the case where the data representing the recording strategy recorded on the NBCA area 11 of the optical disk 10 are read as mentioned above so that the recording apparatus 50 is adjusted, at least a function for reading the data representing the recording strategy and adjusting the apparatus is required as the function of the recording apparatus 50. In order to achieve this, areas are secured in the storage device of the data identification circuit 62 and in the table of the recording strategy setting memory 64 so as to be capable of coping with new recording strategy. The data representing the read recording strategy may be stored in this area. Moreover, the recording signal generating circuit 66 may be constituted so as to be able to change the setting freely so as to be capable of coping with new recording strategy.

Namely, in this embodiment, new recording strategy is not previously recorded but recording strategy read from the NBCA area 11 of the optical disk 10 can be set. Such a structure can be achieved by updating existing processing programs (firmwares) for defining the functions of the data identification circuit 62, recording strategy setting memory 64 and recording signal generating circuit 66. As a result, even the existing recording apparatus 50 manufactured before the shipment of the optical disk 10 of the embodiment can optimally recording information on the optical disk 10 of this embodiment.

What is claimed is:

1. An optical information recording medium capable of at least additional recording, the optical information recording medium comprising:
a specific information recording area for recording, at the time of the additional recording, specific information, which includes at least a type of the recording medium; and
a data recording area which connects with the specific information recording area,
wherein information relating to recording conditions for defining recording signal waveform parameter values at the time of recording is previously recorded onto the specific information recording area.

2. The optical information recording medium of claim 1, wherein the information relating to the recording conditions comprises strategy data representing self recording strategy.

3. The optical information recording medium of claim 1, wherein the information relating to the recording conditions comprises apparatus data representing a recording apparatus.

4. The optical information recording medium of claim 1, wherein the specific information recording area comprises a prerecording area for recording the information before the optical information recording medium is shipped.

5. The optical information recording medium of claim 1, wherein the information relating to the recording conditions comprises differential information from information relating to predetermined reference recording conditions.

6. An optical information recording medium capable of at least additional recording, the optical information recording medium comprising:
a read-only area for copying management and formed on an innermost periphery; and
a data recording area capable of additional recording,
wherein information relating to recording conditions for defining recording signal waveform parameter values at the time of the recording is previously recorded onto the read-only area.

7. The optical information recording medium of claim 6, wherein the information relating to the recording conditions comprises strategy data representing self recording strategy.

8. The optical information recording medium of claim 6, wherein the information relating to the recording conditions comprises apparatus data representing a recording apparatus.

9. The optical information recording medium of claim 6, wherein the read-only area comprises an area for recording NBCA data in the innermost periphery of the medium.

10. The optical information recording medium of claim 6, wherein the information relating to the recording conditions comprises differential information from predetermined reference strategy information.

11. An optical information recording apparatus for recording information onto an optical information recording medium capable of at least additional recording, the optical information recording apparatus comprising:
a storage component for storing information relating to recording conditions, which define recording signal waveform parameter values at the time of recording; and
a recording component for recording the information relating to the recording conditions onto a specific information recording area of the optical information recording medium, which includes at least the specific information recording area for recording specific information including at least a type of the medium at the time of the additional recording and a data recording area which connects with the specific information recording area.

12. An optical information recording apparatus for recording information onto an optical information recording medium capable of at least additional recording, the optical information recording apparatus comprising:
a storage component for storing information relating to recording conditions, which define recording signal waveform parameter values at the time of recording; and
a recording component for recording and adding the information relating to the recording conditions to information to be recorded on a read-only area, for copying management, which read-only area while be formed in an innermost periphery.

13. An optical information recording apparatus for recording information on an optical information recording medium, the optical information recording apparatus comprising:
a storage component for storing information relating to reference recording conditions, which define recording signal waveform parameter values at the time of recording;
a setting component for setting the recording signal waveform parameter values at the time of recording according to the information relating to the reference recording conditions;
an information recording component for recording, onto the optical information recording medium, information in the form of the recording signal waveform parameter values set in the setting component;
a reading component for reading the recorded information relating to the recording conditions; and
an adjusting component for adjusting the recording signal waveform parameter values set by the information relating to the reference recording conditions so that the information is recorded onto the optical information recording medium in the form of the recording signal waveform parameter values based on the information read by the reading component.

14. The optical information recording apparatus of claim 13, wherein the optical information recording medium includes at least a specific information recording area for recording specific information, which includes at least a type of the optical information recording material, and a data recording area, which connects to the specific information recording area, and the reading component reads the information relating to the recording conditions from the specific information recording area.

15. The optical information recording apparatus of claim 14, wherein the reading component reads the information relating to the recording conditions from a prerecording area, to which the information is recorded before the optical information recording medium is shipped.

16. The optical information recording apparatus of claim 13, wherein the optical information recording medium includes at least a read-only area for copying management, which read-only area is formed in an innermost periphery of the optical information recording medium, and a data recording area capable of additional recording, and the reading component reads the information relating to the recording conditions from the read-only area.

17. The optical information recording apparatus of claim 16, wherein the reading component reads the information relating to the recording conditions from a recording area of NBCA data, which recording area is, recorded before the optical information recording medium is shipped.

18. The optical information recording apparatus of claim 13, wherein the reading component reads strategy data representing self recording strategy as the information relating to the recording conditions.

19. The optical information recording apparatus of claim 13, wherein the reading component reads apparatus data representing the recording apparatus as the information relating to the recording conditions.

20. The optical information recording apparatus of claim 13, wherein the reading component reads differential information of information relating to predetermined reference recording conditions as the information relating to the recording conditions.
